(19) United States
(12) Patent Application Publication
(10) Pub. No.: US 2018/0307198 A1
(43) Pub. Date: Oct. 25, 2018

(54) MACHINED SURFACE QUALITY EVALUATION DEVICE

(71) Applicant: FANUC Corporation, Yamanashi (JP)

(72) Inventors: Nobuaki AIZAWA, Yamanashi (JP); Tomokazu KAYANUMA, Yamanashi (JP); Zheng TONG, Yamanashi (JP)

(21) Appl. No.: 15/956,894

(22) Filed: Apr. 19, 2018

(30) Foreign Application Priority Data
Apr. 20, 2017 (JP) 2017-084040

(51) Int. Cl. G05B 19/402; G05B 19/408

(52) U.S. Cl. CPC G05B 19/402; G05B 2219/50177; G05B 19/4083

(57) ABSTRACT

A machined surface quality evaluation device includes a machine learning device that learns a result of evaluation on machined surface quality of a workpiece by an observer which correspond to an inspection result on the machined surface quality of the workpiece. The machine learning device observes the inspection result on the machined surface quality of the workpiece as a state variable, acquires label data indicating the result of the evaluation on the machined surface quality of the workpiece by the observer, and learns the state variable and the label data in a manner such that they are correlated each other.

### BACKGROUND OF THE INVENTION

### 1. Field of the Invention

The present invention relates to a machined surface quality evaluation device and particularly relates to a technique for quantifying an evaluation index for conforming workpieces.

### 2. Description of the Related Art

Conventionally, machining programs have been produced and materials have been machined by control over machine tools based on the machining programs, so that workpieces such as components and dies have been produced. Among quality evaluation indices for workpieces that have been produced in such a manner, there is a machined surface quality. The machined surface quality refers to a degree of smoothness of shape change in a workpiece (inconspicuousness of flaws or streaks on a machined surface and uniformity of light reflection thereon).

Various techniques for improving the machined surface quality have been known. For instance, Japanese Patent Application Laid-Open No. 2017-68325 discloses a method in which an optimal velocity distribution with a balance between the machined surface quality and machining time may be found through machine learning with use of vibration data for a machine tool.

Thus the machined surface quality is one of important quality evaluation indices for workpieces. The machined surface quality is evaluated based on various indices. In one of typical methods of evaluating the machined surface quality, numerical evaluation is made based on various evaluation items that can be observed with use of a laser microscope. For instance, an arithmetical average height (surface roughness) Sa of a surface is a typical evaluation item for the machined surface quality. Other numerical evaluation items are surface maximum height Sv, surface texture aspect ratio Str, kurtosis Sku, skewness Ssk, developed interfacial area ratio Sdr, and the like.

Another important evaluation index for the machined surface quality is imagery of a human being. That is, the index is whether an observer who observes a surface of a machined workpiece determines that an appearance of the surface is “good” or not. In general, it is difficult to quantify an evaluation index that is based on the imagery because judgment criteria for the evaluation index differ among observers. That is, it has not been clarified in what case human beings determine that the appearance is “good”.

As an attempt to quantify an evaluation index that is based on the imagery, it is conceivable to make comparison between a numerical evaluation item (such as the surface roughness Sa) that is acquired from a measuring instrument such as a laser microscope and results of evaluation that are based on the imagery of human beings. It has been found, however, that both are not simply comparable with each other. For instance, it has been conventionally possible to grasp a trend such as what change of property appears on a surface of a workpiece with variation in a numerical evaluation item. The imagery of human beings, however, is compositely intertwined with various numerical evaluation items and thus correlations thereamong have not been clarified. In addition, it is not rare that the imagery of the same surface differs among observers. After all, it depends on feeling of the observer whether the machined surface quality of a machined workpiece is satisfactory or not. This makes it difficult to determine whether workpieces retain constant quality or not. There is another problem in that it is difficult for third parties to understand criteria for a quality evaluation.

### SUMMARY OF THE INVENTION

The invention has been produced in order to solve above problems. An object of the invention is to provide a machined surface quality evaluation device that enables quantification of an evaluation index for conforming workpieces.

A first mode of a machined surface quality evaluation device according to the invention determines a result of evaluation on machined surface quality of a workpiece by an observer, based on an inspection result on the machined surface quality of the workpiece from an inspection device and includes a machine learning device that learns the result of the evaluation on the machined surface quality of the workpiece by the observer which corresponds to the inspection result from the inspection device. The machine learning device includes a state observation unit that observes the inspection result on the machined surface quality of the workpiece from the inspection device, as a state variable, a label data acquisition unit that acquires label data indicating the result of the evaluation on the machined surface quality of the workpiece by the observer, and a learning unit that learns the state variable and the label data in a manner such that they are correlated each other.

The learning unit may include an error calculation unit that calculates an error between a correlation model for determination on the result of the evaluation on the machined surface quality of the workpiece by the observer from the state variable and a correlation characteristic identified from teacher data prepared in advance and a model update unit that updates the correlation model so as to reduce the error.

The learning unit may carry out calculation of the state variable and the label data in a multi-layer structure.

The machined surface quality evaluation device may further include a determination output unit that outputs the result of the evaluation on the machined surface quality of the workpiece by the observer that has been determined based on a result of learning by the learning unit. The determination output unit may output a warning when the result of the evaluation on the machined surface quality of the workpiece by the observer that has been determined by the learning unit exceeds a preset threshold.

The inspection result on the machined surface quality of the workpiece from the inspection device may be a value acquired with use of at least one of a surface roughness Sa, a surface maximum height Sv, surface texture aspect ratio Str, kurtosis Sku, skewness Ssk, developed interfacial area ratio Sdr, light reflectance, an image feature of the workpiece.

The inspection device may be made to carry out a predetermined operation for determination on the result of the evaluation on the machined surface quality of the workpiece by the observer, with use of the learning unit.

The predetermined operation for the determination may be carried out automatically or in response to a request from an operator.

The machined surface quality evaluation device may be configured as a portion of the inspection device.

The machined surface quality evaluation device may be configured as a portion of a management device that manages a plurality of the inspection devices through a network.

A second mode of a machined surface quality evaluation device according to the invention determines a result of evaluation on machined surface quality of a workpiece by an observer, based on an inspection result on the machined surface quality of the workpiece from an inspection device and includes a model that represents a correlation between the inspection result on the machined surface quality of the workpiece from the inspection device and label data indicating the result of the evaluation on the machined surface quality of the workpiece by the observer and a determination output unit that outputs the result of the evaluation on the machined surface quality of the workpiece by the observer that has been determined based on the model.

According to the invention, the machined surface quality evaluation device that enables quantification of an evaluation index for conforming workpieces can be provided.

### BRIEF DESCRIPTION OF THE DRAWINGS

FIG. 1 is a schematic functional block diagram illustrating a machined surface quality evaluation device according to a first embodiment of the invention.

FIG. 2 is a schematic functional block diagram illustrating a mode of the machined surface quality evaluation device.

FIG. 3A is a diagram illustrating neurons.

FIG. 3B is a diagram illustrating a neural network.

FIG. 4 is a schematic functional block diagram illustrating a machined surface quality evaluation device according to a second embodiment of the invention.

FIG. 5 is a schematic functional block diagram illustrating a mode of a machined surface quality evaluation system.

FIG. 6 is a schematic functional block diagram illustrating another mode of the machined surface quality evaluation system.

FIG. 7 is a schematic functional block diagram illustrating a mode of a machined surface quality evaluation system that includes a management device.

### DETAILED DESCRIPTION OF THE PREFERRED EMBODIMENTS

Hereinbelow, configuration examples of a machined surface quality evaluation device that is an embodiment of the invention will be described. A configuration of the machined surface quality evaluation device of the invention, however, is not limited to the examples below and any configuration may be employed as long as the configuration may attain the object of the invention.

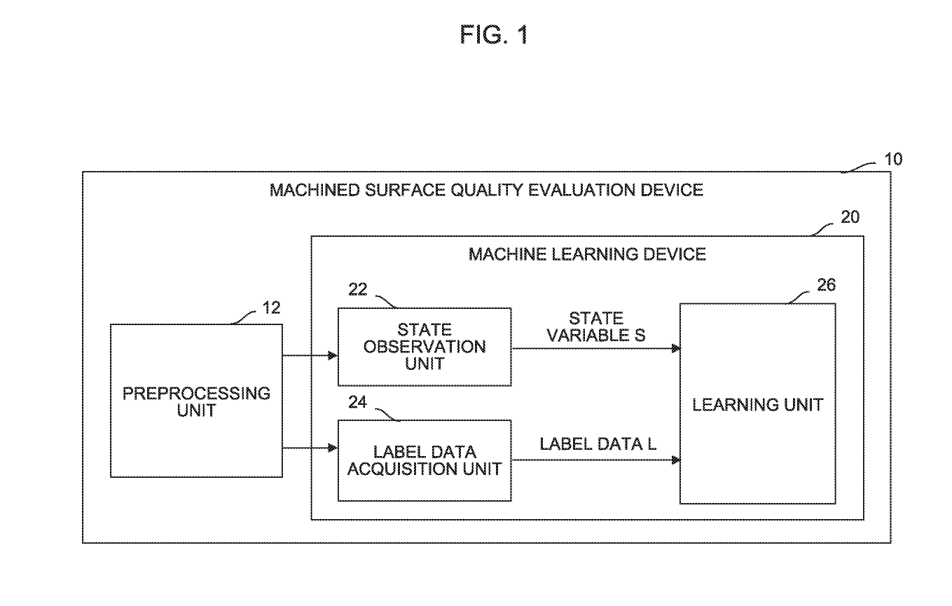

FIG. 1 is a functional block diagram that illustrates a schematic configuration of a machined surface quality evaluation device 10 that is the embodiment of the invention.

The machined surface quality evaluation device 10 may be implemented as a computer or the like that is connected via a wired or wireless communication line to an inspection device (not illustrated) for machined workpieces so as to be capable of carrying out data communication, for instance. Though the inspection device may be a machined surface analyzer (typically, laser microscope), a machined surface imaging unit, optical reflectance measuring equipment, or the like, for instance, the inspection device is not limited to those. The machined surface quality evaluation device 10 includes a preprocessing unit 12 that performs preprocessing for data acquired from the inspection device and a machine learning device 20 that includes software (such as a learning algorithm) and hardware (such as a CPU of a computer) for self-learning on evaluation of machined surface quality through so-called machine learning. The evaluation of the machined surface quality that is learned by the machine learning device 20 corresponds to a model structure that represents a correlation between inspection results from the inspection device (numerical data acquired from the inspection device) and results of the evaluation by an observer (results of imagery evaluation on the machined surface quality) on workpieces from which the inspection results have been acquired.

As illustrated by functional blocks in FIG. 1, the machine learning device 20 included in the machined surface quality evaluation device 10 includes a state observation unit 22 that observes the numerical data, indicating the inspection result on a workpiece acquired from the inspection device (not illustrated), as a state variable S representing a current state of environment, a label data acquisition unit 24 that acquires label data L indicating the result of the evaluation by an observer on the workpiece, and a learning unit 26 that learns the label data L associated with the state variable S.

The preprocessing unit 12 may be configured as a function of a CPU of a computer or may be configured as software for making a CPU of a computer function, for instance. The preprocessing unit 12 performs preprocessing for data acquired from the inspection device or a sensor mounted on the inspection device, data acquired by use or conversion of the data, or the like, and outputs the preprocessed data to the state observation unit 22. The preprocessing unit 12 acquires the result of the evaluation by an observer on a workpiece, that is, the result of the evaluation on the machined surface quality that is based on the imagery, from an input unit (not illustrated), performs necessary preprocessing for the result, and outputs the preprocessed data to the label data acquisition unit 24.

The preprocessing which the preprocessing unit 12 performs in order to acquire the state variable S includes various publicly-known processes for evaluating surface roughness Sa, surface maximum height Sv, surface texture aspect ratio Str, kurtosis Sku, skewness Ssk, developed interfacial area ratio Sdr, light reflectance on the machined workpiece, an image feature of the machined surface, or the like, for instance. The preprocessing which the preprocessing unit 12 performs in order to acquire the label data L includes input and analysis of a file in which the result of the evaluation by an observer is recorded, acquisition and analysis of the result of the evaluation by an observer that is directly inputted through an interface such as a keyboard, or the like, for instance.

The state observation unit 22 may be configured as a function of a CPU of a computer or may be configured as software for making a CPU of a computer function, for instance. As the numerical data that is the state variable S to be observed by the state observation unit 22, data indicating the inspection result on the machined surface may be used, for instance. The data includes data processed by the preprocessing unit 12 for the data acquired from the inspection device or the sensor provided on the inspection device and the data acquired by use or conversion of the data.

The state variable S may include identification data representing an observer who performs evaluation on the label data L which will be described later, more specifically, a person in charge, an operator, or the like. Thus a relationship between the inspection results on the machined surface quality from the inspection device and the results of the evaluation on the machined surface quality that is based on the imagery of the observer can be learned independently for each observer. Even if criteria for the imagery evaluation on the machined surface quality differ among observers, consequently, the appropriate result of the evaluation on the machined surface quality that is based on the imagery of an observer corresponding to the inspection result on the machined surface quality from the inspection device can be outputted. In case where the identification data representing the observer is not included in the state variable S, a general result of the evaluation in which there is no distinction among the observers can be acquired.

The state variable S may include identification data representing an object location for the evaluation on the label data L which will be described later, that is, a location on the machined workpiece where the machined surface quality is to be evaluated. Thus the relationship between the inspection results on the machined surface quality from the inspection device and the results of the evaluation on the machined surface quality that is based on the imagery of an observer can be learned independently for each object location. Even if the criteria for the imagery evaluation on the machined surface quality differ among object locations, consequently, the appropriate result of the evaluation on the machined surface quality that is based on the imagery of the observer corresponding to the inspection result on the machined surface quality from the inspection device can be outputted.

The label data acquisition unit 24 may be configured as a function of a CPU of a computer or may be configured as software for making a CPU of a computer function, for instance. As the label data L to be acquired by the label data acquisition unit 24, data that has been preprocessed by the preprocessing unit 12 on declared data given to the machined surface quality evaluation device 10 as a result of the evaluation of the machined workpiece by an observer may be used, for instance. The label data L indicates the result of the evaluation on the machined surface quality under the state variable S that is based on the imagery of the observer. The result of the evaluation that is based on the imagery of the observer may be a binary value that indicates whether a machined workpiece is conforming or not or may be a multiple value such as levels 1 to 10, for instance.

During learning by the machine learning device 20 included in the machined surface quality evaluation device 10, machining by a machine tool, measurement by the inspection device on an evaluation item indicating an aspect of the machined surface quality of the machined workpiece, and determination by an observer on the machined surface quality are carried out in the environment.

The learning unit 26 may be configured as a function of a CPU of a computer or may be configured as software for making a CPU of a computer function, for instance. The learning unit 26 learns the evaluation on the machined surface quality in accordance with a desired learning algorithm that is generically referred to as machine learning. The learning unit 26 is capable of iteratively executing learning that is based on a data set including the state variables S and the label data L that relate to the machined surface quality of machined workpieces.

Iteration of such a learning cycle makes it possible for the learning unit 26 to automatically identify a characteristic that implies the correlation between the inspection results from the inspection device (numerical data acquired from the inspection device) and the results of the evaluation by an observer (results of the imagery evaluation on the machined surface quality) on the workpieces from which the inspection results have been acquired. Though the correlation between the inspection results from the inspection device and the results of the evaluation by the observer on the workpieces is substantially unknown at a start of the learning algorithm, the learning unit 26 interprets the correlation by gradually identifying the characteristic that represents the correlation as the learning advances. When the correlation between the inspection results from the inspection device and the results of the evaluation by the observer on the workpieces is interpreted to a level that is reliable to a certain degree, results of the learning that are iteratively outputted by the learning unit 26 are made usable for behavior selection (that is, decision making) as to how the result of the evaluation as the imagery of a human being is to be determined in relation to a current inspection result. That is, by the learning unit 26, the correlation between the inspection results from the inspection device and behavior as to how the result of the evaluation as the imagery of the observer is to be determined in relation to the current inspection result can be gradually made closer to an optimal solution with advance in the learning algorithm.

In the machine learning device 20 included in the machined surface quality evaluation device 10, as described above, the learning unit 26 learns the result of the evaluation as the imagery of an observer that corresponds to the inspection result from the inspection device, in accordance with the machine learning algorithm with use of the state variable S observed by the state observation unit 22 and the label data L acquired by the label data acquisition unit 24. The state variable S is configured with use of the inspection result from the inspection device, which is data hardly influenced by disturbance, and the label data L is unambiguously found based on the declared data from an observer. According to the machine learning device 20 included in the machined surface quality evaluation device 10, with use of the results of the learning by the learning unit 26, therefore, determination on the result of the evaluation as the imagery of the observer that corresponds to the inspection result from the inspection device can be made automatically and accurately without calculation or estimation.

Provided that the determination on the result of the evaluation as the imagery of an observer can be made automatically without calculation or estimation, the result of the evaluation on a workpiece as the imagery of the observer can be promptly estimated only by an inspection in the inspection device after machining of the workpiece by a machine tool. As a result, time taken for the determination on the result of the evaluation on the machined surface quality as the imagery of the observer can be shortened. Additionally, an operator is enabled to determine whether a machined workpiece is conforming or not based on contents of the determination by the machined surface quality evaluation device 10 and to easily do tuning for improving the machined surface quality or the like.

In a modification of the machine learning device 20 included in the machined surface quality evaluation device 10, the learning unit 26 is capable of using the state variable S and the label data L that are acquired for each of a plurality of inspection devices and thereby learning the result of the evaluation on the machined surface quality as the imagery of an observer that corresponds to the inspection result from each of the inspection devices. According to this configuration, in which a quantity of data sets including the state variables S and the label data L that can be acquired within a given period can be increased, a speed, reliability, and the like of the learning of the results of the evaluation on the machined surface quality as the imagery of the observer that correspond to the inspection results from the inspection devices can be improved with more diverse data sets used as input.

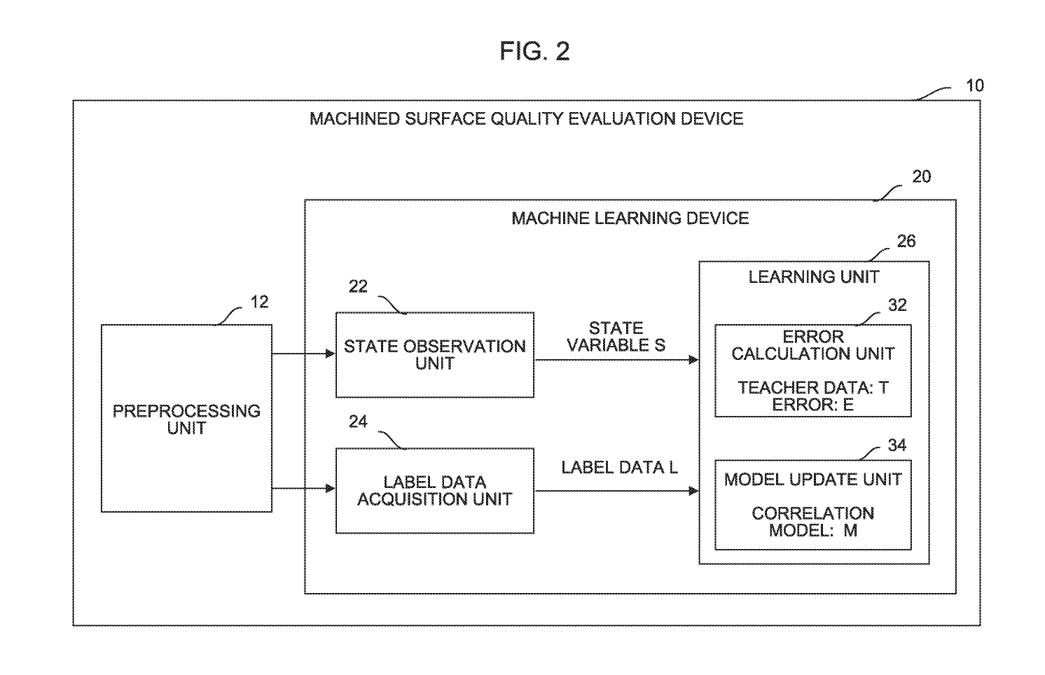

In the machine learning device 20 having the above configuration, there is no particular limitation on the learning algorithm that is executed by the learning unit 26 and a learning algorithm that is publicly known for machine learning may be employed. FIG. 2 illustrates a mode of the machined surface quality evaluation device 10 illustrated in FIG. 1 and a configuration that includes the learning unit 26 which carries out supervised learning as an example of the learning algorithm.

The supervised learning is a technique in which a large amount of known data sets (which will be referred to as teacher data) of input and corresponding output are provided in advance and in which a correlation model for estimation of a necessary output for a fresh input (the result of the evaluation on the machined surface quality as the imagery of an observer that corresponds to the inspection result from the inspection device in the machine learning device 20 of the application) is learned by identification of the characteristic that implies the correlation between the input and the output from the teacher data.

In the machine learning device 20 included in the machined surface quality evaluation device 10 illustrated in FIG. 2, the learning unit 26 includes an error calculation unit 32 that calculates an error E between the correlation model M for derivation of the result of the evaluation on the machined surface quality as the imagery of an observer from the state variable S and the correlation characteristic identified from the teacher data T prepared in advance and a model update unit 34 that updates the correlation model M so as to reduce the error E. The learning unit 26 learns the results of the evaluation on the machined surface quality as the imagery of the observer that correspond to the inspection results from the inspection device, with iterative update of the correlation model M by the model update unit 34.

The correlation model M can be constructed through regression analysis, reinforcement learning, deep learning, or the like. An initial value of the correlation model M is given to the learning unit 26 before a start of the supervised learning, as a simplified expression of the correlation between the state variables S and the results of the evaluation on the machined surface quality as the imagery of an observer, for instance. The teacher data T can be composed of configured from experience values (known data sets of the inspection results from the inspection device and the results of the evaluation on the machined surface quality as the imagery of the observer) accumulated by recording of the results of the evaluation on the machined surface quality as the imagery of the observer that correspond to the past inspection results from the inspection device, for instance, and is given to the learning unit 26 before the start of the supervised learning. The error calculation unit 32 identifies the correlation characteristic that implies the correlation between the inspection results from the inspection device and the results of the evaluation on the machined surface quality as the imagery of the observer from the large amount of teacher data T given to the learning unit 26 and finds the error E between the correlation characteristic and the correlation model M corresponding to the state variable S in the current state. The model update unit 34 updates the correlation model M so as to reduce the error E in accordance with a predetermined update rule, for instance.

In a subsequent learning cycle, the error calculation unit 32 uses the state variable S acquired from the inspection by the inspection device and the label data L that is the result of the evaluation by an observer in accordance with the updated correlation model M and thereby finds the error E relating to the correlation model M corresponding to the state variable S and the label data L and then the model update unit 34 updates the correlation model M afresh. Thus the correlation between the current state of the environment (the inspection result from the inspection device) and the determination on the corresponding state (the result of the evaluation as the imagery of an observer) that has been unknown is gradually clarified. In other words, with the update of the correlation model M, a relationship between the inspection result from the inspection device and the result of the evaluation as the imagery of the observer is gradually made to approach the optimal solution.

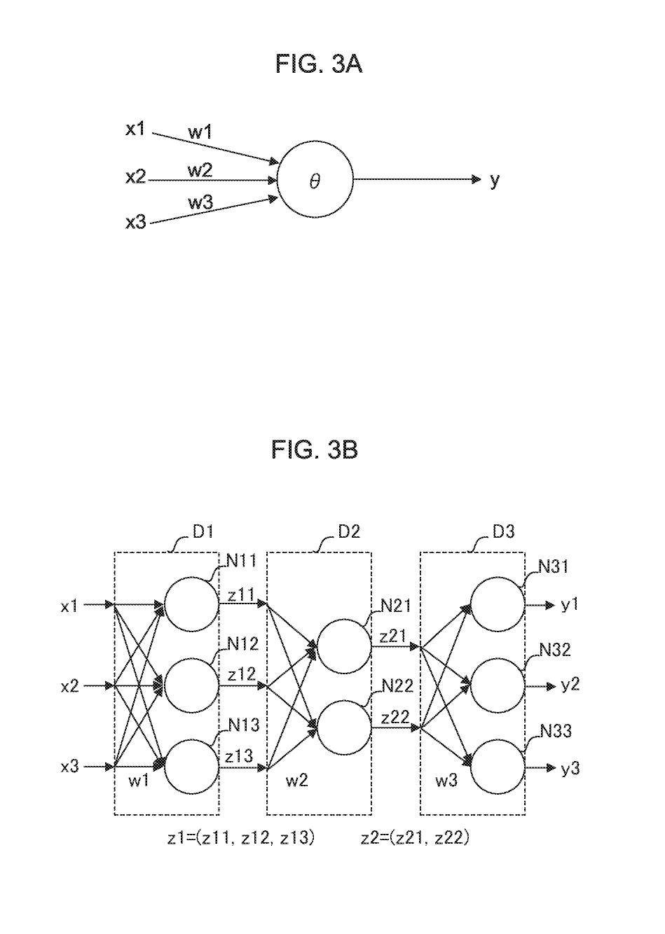

For the supervised learning described above, a neural network may be used, for instance. FIG. 3A schematically illustrates a model of neurons. FIG. 3B schematically illustrates a model of a three-layer neural network configured by combination of the neurons illustrated in FIG. 3A. The neural network may be configured with use of arithmetic units, storage devices, and the like that are modeled after a neuron model, for instance.

The neurons illustrated in FIG. 3A output a result y of a plurality of inputs x (inputs x₁ to x₃, as an example). The inputs x₁ to x₃ are multiplied by weights w (w₁ to w₃) corresponding to the inputs x. Thus the neurons output the output y expressed by equation (1) below. In equation (1), all of the inputs x, the output y, and the weights w are vectors. θ is a bias and fₖ is an activating function.

y=fₖ(Σᵢ₌₁ⁿxᵢwᵢ−θ) (1)

In the three-layer neural network illustrated in FIG. 3B, a plurality of inputs x (inputs x1 to x3, as an example) are inputted from a left side and results y (results y1 to y3, as an example) are outputted from a right side. In an example illustrated in FIG. 3B, the inputs x1, x2, and x3 are respectively multiplied by corresponding weights (generically represented as w1) and the inputs x1, x2, and x3 are each inputted into three neurons N11, N12, and N13.

In FIG. 3B, outputs from the neurons N11 to N13 are generically represented as z1. z1 can be regarded as feature vectors in which feature amounts of the input vectors are extracted. In the example illustrated in FIG. 3B, the feature vectors z1 are respectively multiplied by corresponding weights (generically represented as w2) and are each inputted into two neurons N21 and N22. The feature vectors z1 represent features between the weights w1 and the weights w2.

In FIG. 3B, outputs from the neurons N21 and N22 are generically represented as z2. z2 can be regarded as feature vectors in which feature amounts of the feature vectors z1 are extracted. In the example illustrated in FIG. 3B, the feature vectors z2 are respectively multiplied by corresponding weights (generically represented as w3) and are each inputted into three neurons N31, N32, and N33. The feature vectors z2 represent features between the weights w2 and the weights w3. Lastly, the neurons N31 to N33 respectively output the results y1 to y3.

In the machine learning device 20 included in the machined surface quality evaluation device 10, the learning unit 26 carries out calculations of multi-layer structure pursuant to the above-described neural network with the state variable S used as the inputs x, so that the results (results y) of the evaluation on the machined surface quality as the imagery of the human being can be outputted. Operation modes of the neural network include a learning mode and a determination mode. The weights w can be learned with use of the learning data sets in the learning mode and the determination on the result of the evaluation on the machined surface quality as the imagery of the human being can be made with use of the learned weights w in the determination mode, for instance. In the determination mode, detection, classification, inferencing, and the like can also be carried out.

The configuration of the above-described machined surface quality evaluation device 10 can be described as a machine learning method (or software) that is executed by a CPU of a computer. The machine learning method is a machine learning method of learning the result of the evaluation on the machined surface quality as the imagery of the human being that corresponds to the inspection result from the inspection device and includes:

a step of making the CPU of the computer observe the state variable S that indicates the inspection result from the inspection device;

a step of acquiring the label data L that indicates the result of the evaluation on the machined surface quality as the imagery of the human being; and

a step of learning the inspection result from the inspection device and the result of the evaluation on the machined surface quality, as the imagery of the human being, in a manner such that they are correlated each other, with use of the state variable S and the label data L.

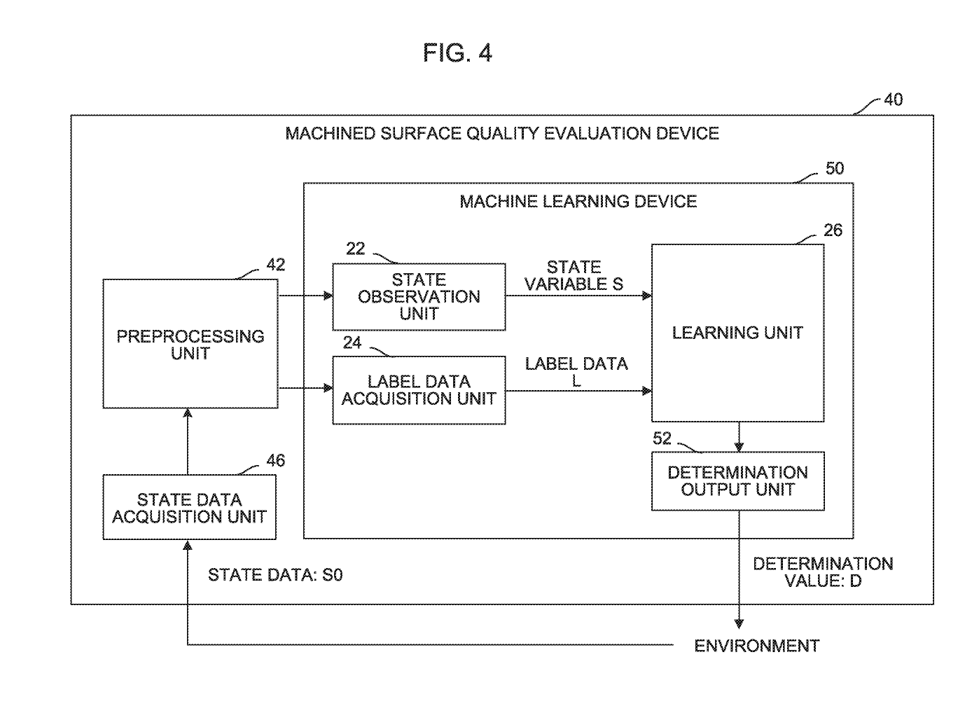

FIG. 4 illustrates a machined surface quality evaluation device 40 according to a second embodiment.

The machined surface quality evaluation device 40 includes a preprocessing unit 42, a machine learning device 50, and a state data acquisition unit 46. The state data acquisition unit 46 acquires, as state data S0, data inputted from an inspection device, a sensor provided on the inspection device, or appropriate data input by an operator into the preprocessing unit 42.

The machine learning device 50 included in the machined surface quality evaluation device 40 includes software (such as an arithmetic algorithm) and hardware (such as a CPU of a computer) for output of the result of the evaluation based on the imagery of an observer determined by the learning unit 26 based on the inspection result from the inspection device, as display of characters on a display (not illustrated), output of sounds or voice from a speaker (not illustrated), output through an alarm lamp (not illustrated), or combination thereof, in addition to the software (such as a learning algorithm) and the hardware (such as a CPU of a computer) for the self-learning through the machine learning on the result of the evaluation based on the imagery of an observer that corresponds to the inspection result from the inspection device. The machine learning device 50 may have a configuration in which one common CPU executes all software such as the learning algorithm and the arithmetic algorithm.

A determination output unit 52 may be configured as a function of a CPU of a computer, for instance. Alternatively, the determination output unit 52 may be configured as software for making a CPU of a computer function, for instance. The determination output unit 52 outputs instructions so as to notify an operator of the result of the evaluation based on the imagery of an observer that has been determined by the learning unit 26 based on the inspection result from the inspection device, as the display of characters, the output of sounds or voice, the output through the alarm lamp, or combination thereof. The determination output unit 52 may output the instructions for notification to a display or the like included in the machined surface quality evaluation device 40 or may output the instructions for notification to a display or the like included in the inspection device.

The machine learning device 50 included in the machined surface quality evaluation device 40 having an above configuration achieves effects equivalent to effects of the machine learning device 20 described above and illustrated in FIGS. 1 and 2. Additionally, the machine learning device 50 illustrated in FIG. 4 is capable of changing a state of the environment by output from the determination output unit 52. In the machine learning device 20 illustrated in FIGS. 1 and 2, on the other hand, a function equivalent to the determination output unit for reflection of the results of the learning by the learning unit 26 in the environment may be sought in an external device (such as a controller for a machine tool).

In a modification of the machined surface quality evaluation device 40, the determination output unit 52 may set a predetermined threshold for each of the results of the evaluation by an observer determined by the learning unit 26 based on the inspection results from the inspection device and may output information as a warning when a result of the evaluation by the observer that is determined by the learning unit 26 based on the inspection result from the inspection device falls below the threshold.

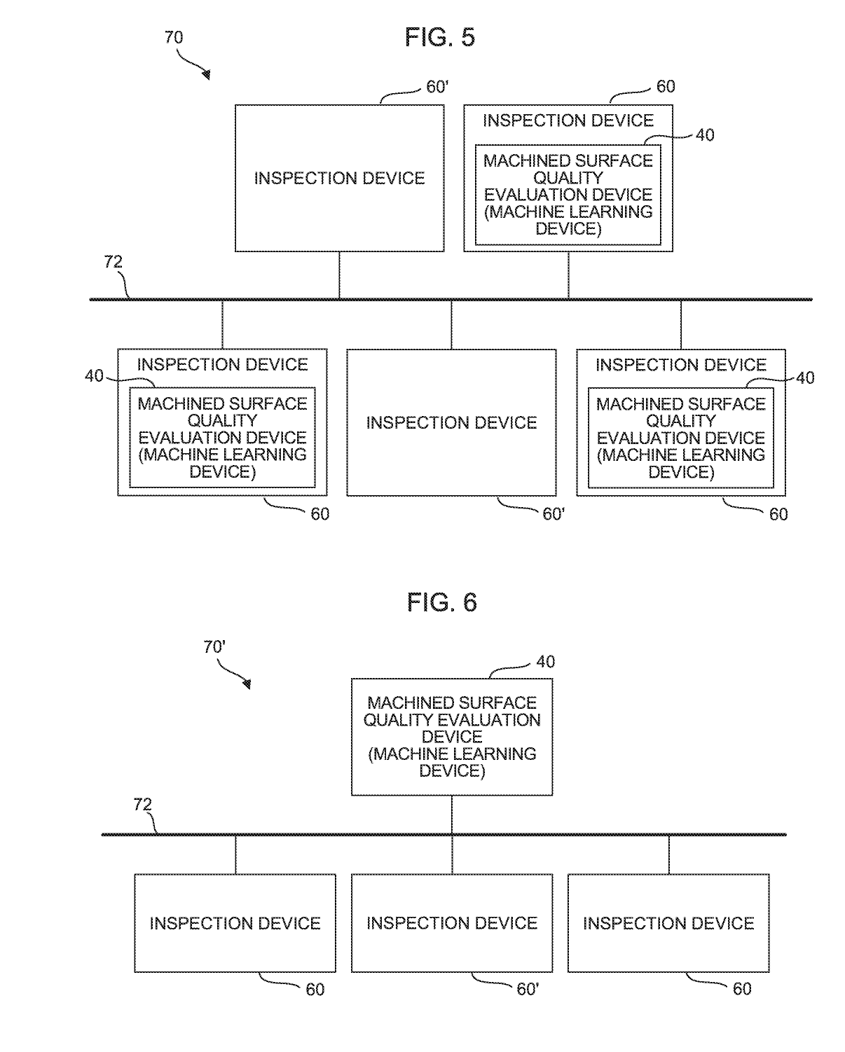

FIG. 5 illustrates a machined surface quality evaluation system 70 according to an embodiment that includes inspection devices 60. The machined surface quality evaluation system 70 includes a plurality of inspection devices 60, 60′ that are capable of conducting a similar inspection having similar contents and accuracy and a network 72 that connects the inspection devices 60, 60′. At least one of the plurality of inspection devices 60, 60′ is configured as the inspection device 60 that includes the above-described machined surface quality evaluation device 40. The machined surface quality evaluation system 70 may include the inspection devices 60′ that do not include the machined surface quality evaluation device 40. The inspection devices 60, 60′ have an ordinary configuration necessary for an inspection of the machined surface quality of a machined workpiece.

In the machined surface quality evaluation system 70 having an above configuration, the inspection devices 60 that include the machined surface quality evaluation devices 40, among the plurality of inspection devices 60, 60′, are each capable of automatically and accurately finding the result of the evaluation based on the imagery of an observer that corresponds to the inspection result from the inspection device 60 with use of the results of the learning by the learning unit 26 without calculation or estimation. The machined surface quality evaluation device 40 of at least one inspection device 60 may be configured to learn the results of the evaluation based on the imagery of the observer that correspond to the inspection results from the inspection devices 60, 60′ which are common to all the inspection devices 60, 60′, based on the state variable S and the label data L that are acquired for each of the plurality of other inspection devices 60, 60′ and all the inspection devices 60, 60′ may be configured to share results of such learning. According to the machined surface quality evaluation system 70, consequently, the speed, reliability, and the like of the learning of the results of the evaluation based on the imagery of the observer that correspond to the inspection results from the inspection devices can be improved with use of more diverse data sets (including the state variables S and the label data L) as the input.

FIG. 6 illustrates a machined surface quality evaluation system 70′ according to another embodiment that includes the inspection devices 60′.

The machined surface quality evaluation system 70′ includes the machined surface quality evaluation device 40 (or 10), the plurality of inspection devices 60′ that are capable of conducting an inspection having the same contents and accuracy, and the network 72 that connects the inspection devices 60′ and the machined surface quality evaluation device 40 (or 10).

In the machined surface quality evaluation system 70′ having an above configuration, the machined surface quality evaluation device 40 (or 10) may learn the results of the evaluation based on the imagery of an observer that correspond to the inspection results from the inspection devices which are common to all the inspection devices 60′, based on the state variable S and the label data L that are acquired for each of the plurality of inspection devices 60′, and thus the results of the evaluation based on the imagery of the observer that correspond to the inspection results from the inspection devices can be automatically and accurately found with use of results of such learning without calculation or estimation.

The machined surface quality evaluation system 70′ may have a configuration in which the machined surface quality evaluation device 40 (or 10) exists in a cloud server prepared in the network 72. According to this configuration, a necessary number of inspection devices 60′ can be connected to the machined surface quality evaluation device 40 (or 10) when necessary, irrespective of places where and periods when the plurality of inspection devices 60′ exist.

The operator who engages in the machined surface quality evaluation system 70, 70′ may make determination as to whether an attainment level of the learning of the results of the evaluation by the machined surface quality evaluation device 40 (or 10), based on the imagery of an observer, that correspond to the inspection results from the inspection devices has reached a requirement level or not, at appropriate time after the start of the learning by the machined surface quality evaluation device 40 (or 10).

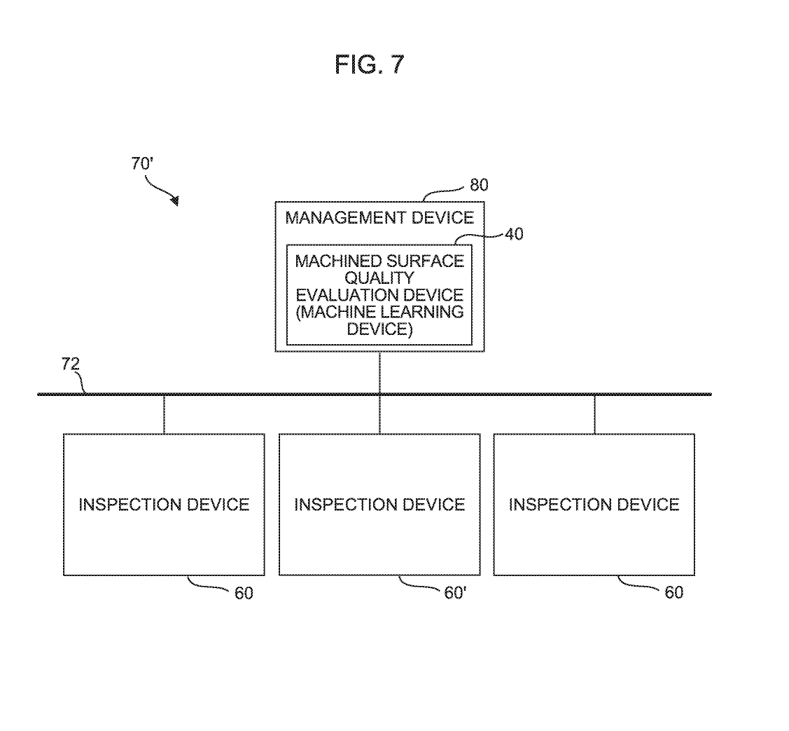

In a modification of the machined surface quality evaluation system 70, 70′, the machined surface quality evaluation device 40 may be implemented so as to be integrated in a management device 80 that manages the inspection devices 60, 60′. As illustrated in FIG. 7, the plurality of inspection devices 60, 60′ are connected to the management device 80 through the network 72 and the management device 80 collects data relating to operating conditions, the inspection results, and the like in the inspection devices 60, 60′ through the network 72. The management device 80 may receive information from desired inspection devices 60, 60′, may instruct the machined surface quality evaluation device 40 to determine the inspection results from the inspection devices 60, 60′, and may output results of determination onto a display provided in the management device 80 or the like or to the inspection devices 60, 60′ subjected to the determination. Such a configuration makes it possible to unify management of the results of the determination on the inspection devices 60, 60′ and the like in the management device 80 and to collect the state variables to be samples from the plurality of inspection devices 60, 60′ in relearning and thus has an advantage in that a large amount of data for the relearning can be easily collected.

Though the embodiments of the invention have been described above, the invention is not limited to the embodiments described above and can be embodied in various manners with appropriate modification.

For instance, the learning algorithms that are executed by the machine learning devices 20, 50, the arithmetic algorithm that is executed by the machine learning device 50, control algorithms that are executed by the machined surface quality evaluation devices 10, 40, and the like are not limited to the above and various algorithms may be employed.

Though the preprocessing unit 12 is provided on the machined surface quality evaluation device 40 (or the machined surface quality evaluation device 10) in the above-described embodiments, the preprocessing unit 12 may be provided on the inspection device. In this case, the preprocessing may be carried out in either of the machined surface quality evaluation device 40 (or the machined surface quality evaluation device 10) or the inspection device or may be carried out in both. Sites to be processed may be appropriately set in consideration of processing capacity and communication speed.

Though the examples in which the learning unit 26 uses the algorithm of the supervised learning have been mainly described for the above-described embodiments, the invention is not limited to the examples. For instance, the state observation unit 22 may be configured to input only the inspection results from the inspection device on workpieces that have been determined as conforming workpieces by an observer, as the state variables S, and the learning unit 26 may be configured to form a cluster that represents a feature of the inspection results on the workpieces that have been determined as conforming workpieces pursuant to an unsupervised learning algorithm. In this example, the learning unit 26 may determine whether the inspection results from the inspection device on machined workpieces that have been newly produced belong to the cluster or not and may thereby estimate the results of the evaluation on the machined workpieces that are based on the imagery of the observer. Whether an inspection result belongs to the cluster or not can be determined based on a threshold determination on a distance from a center of the cluster or the like, for instance.

In this technique, learning processes may be made independent for each observer or each object location, for instance. That is, the learning may be carried out with use of a different learning unit 26 for each observer or each object location. Thus a different cluster is formed for each observer or each object location, so that the relationship between the inspection results on the machined surface quality from the inspection device and the results of the evaluation on the machined surface quality that are based on the imagery of an observer can be learned independently for each observer or each object location. Even if the criteria for the imagery evaluation on the machined surface quality differ among observers or object locations, consequently, the appropriate result of the evaluation on the machined surface quality that is based on the imagery of the observer corresponding to the inspection result on the machined surface quality from the inspection device can be outputted.

1. A machined surface quality evaluation device that determines a result of evaluation on machined surface quality of a workpiece by an observer, based on an inspection result on the machined surface quality of the workpiece from an inspection device, the machined surface quality evaluation device comprising:
a machine learning device that learns the result of the evaluation on the machined surface quality of the workpiece by the observer which corresponds to the inspection result from the inspection device, wherein
the machine learning device includes
a state observation unit that observes the inspection result on the machined surface quality of the workpiece from the inspection device, as a state variable,
a label data acquisition unit that acquires label data indicating the result of the evaluation on the machined surface quality of the workpiece by the observer, and
a learning unit that learns the state variable and the label data in a manner such that they are correlated each other.

2. The machined surface quality evaluation device according to claim 1, wherein the learning unit includes
an error calculation unit that calculates an error between a correlation model for determination on the result of the evaluation on the machined surface quality of the workpiece by the observer from the state variable and a correlation characteristic identified from teacher data prepared in advance, and
a model update unit that updates the correlation model so as to reduce the error.

3. The machined surface quality evaluation device according to claim 1, wherein the learning unit carries out calculation of the state variable and the label data in a multi-layer structure.

4. The machined surface quality evaluation device according to claim 1, further comprising:
a determination output unit that outputs the result of the evaluation on the machined surface quality of the workpiece by the observer that has been determined based on a result of learning by the learning unit.

5. The machined surface quality evaluation device according to claim 4, wherein the determination output unit outputs a warning when the result of the evaluation on the machined surface quality of the workpiece by the observer that has been determined by the learning unit exceeds a preset threshold.

6. The machined surface quality evaluation device according to claim 1, wherein the inspection result on the machined surface quality of the workpiece from the inspection device is a value acquired with use of at least one of surface roughness Sa, maximum height Sv, surface texture aspect ratio Str, kurtosis Sku, Ssk, developed interfacial area ratio Sdr, light reflectance, and an image feature of the workpiece.

7. The machined surface quality evaluation device according to claim 1, wherein the inspection device is made to carry out a predetermined operation for determination on the result of the evaluation on the machined surface quality of the workpiece by the observer, with use of the learning unit.

8. The machined surface quality evaluation device according to claim 7, wherein the predetermined operation for the determination is carried out automatically or in response to a request from an operator.

9. The machined surface quality evaluation device according to claim 1, wherein the machined surface quality evaluation device is configured as a portion of the inspection device.

10. The machined surface quality evaluation device according to claim 1, wherein the machined surface quality evaluation device is configured as a portion of a management device that manages a plurality of the inspection devices through a network.

11. A machined surface quality evaluation device that determines a result of evaluation on machined surface quality of a workpiece by an observer, based on an inspection result on the machined surface quality of the workpiece from an inspection device, the machined surface quality evaluation device comprising:
a model that represents a correlation between the inspection result on the machined surface quality of the workpiece from the inspection device and label data indicating the result of the evaluation on the machined surface quality of the workpiece by the observer, and
a determination output unit that outputs the result of the evaluation on the machined surface quality of the workpiece by the observer that has been determined based on the model.
